(19) United States
(12) Patent Application Publication
(10) Pub. No.: US 2010/0300929 A1
(43) Pub. Date: Dec. 2, 2010

(54) COMPOSITIONS AND METHODS FOR IMPROVING A CATALYTIC REFORMER

(76) Inventors: Allen A. ARADI, Glen Allen, VA (US); Joseph W. ROOS, Mechanicsville, VA (US); Michael W. MEFFERT, Chesterfield, VA (US)

Correspondence Address: Mannava & Kang, P.C., 11240 Waples Mill Road, Suite 300, Fairfax, VA, 22030, US

(21) Appl. No.: 12/472,736

(22) Filed: May 27, 2009

(51) Int. Cl. C10L 1/04; B01J 23/34; C10G 35/06; B01J 8/00

(52) U.S. Cl. 208/16; 502/324; 208/134; 422/129

(57) ABSTRACT

The present disclosure relates to a catalytic reformer system, including a feed stream to a catalytic reformer comprising naphtha and at least one manganese-containing compound. There is also disclosed a reformer catalyst. Methods of improving the reformer catalyst durability are also disclosed.

### FIELD OF THE DISCLOSURE

The present disclosure relates to a feed stream to a catalytic reformer comprising naphtha and at least one manganese-containing compound. Inside the catalytic reforming unit, the manganese-containing compound can decompose to free manganese species that can deposit on the reformer catalyst and/or scavenge catalyst poisons thereby improving the durability of the catalyst. Moreover, manganese deposited on the catalyst can act as a secondary reforming catalyst. Further, any manganese-containing compound that does not decompose can increase the octane blend value of the reformate.

### BACKGROUND OF THE DISCLOSURE

Crude oil can be easily separated into its principal components, i.e. butanes and light gases, naphtha, distillate fractions, gas oils and residual fuels, by simple distillation. Catalytic reforming is used to increase the octane of gasoline boiling range components. The feed is usually naphtha boiling in the 80-210° C. range, and the catalysts used can be platinum on alumina, normally with small amounts of other metals such as rhenium. Depending upon the catalysts and operating conditions, the following types of reactions occur to a greater or lesser extent: 1. Paraffins undergo dehydrocyclization to form aromatics; 2. Cycloparaffins dehydrogenate to form corresponding aromatics; 3. Straight-chain paraffins isomerizes into branched-chain paraffins; 4. Heavy paraffins are hydrocracked into lighter paraffins; 5. Olefins are saturated and subsequently react in a manner similar to corresponding paraffins.

A problem of operating a catalytic reformer in a refinery is coking of the catalyst. This necessitates the employment of some means to regenerate catalyst performance by removing coke via controlled oxidation. This regeneration must be accomplished with the catalyst offline, whether by continuous removal of the catalyst from the reforming reactor and regeneration in a secondary vessel or through regular shut down of the reforming unit to remove coke from the catalyst via oxidative regeneration.

What is needed is a method and system that increases the durability of the catalyst and/or increases the octane blend value of the reformate product stream.

### SUMMARY OF THE DISCLOSURE

In accordance with the disclosure, there is disclosed herein a feed stream to a catalytic reformer comprising naphtha and at least one manganese-containing compound.

There is also disclosed a catalytic reformer system comprising: a feed stream comprising naphtha and at least one manganese-containing compound; and a catalyst.

In an aspect, there is also disclosed a reformer catalyst comprising: a support; a noble metal on the support; and a deposit of free manganese species on the catalyst.

In a further aspect, there is disclosed a method to improve the durability of a reformer catalyst comprising: adding to a naphtha feed stream at least one manganese-containing compound, wherein the at least one manganese-containing compound decomposes and deposits free manganese species on the reforming catalyst.

Moreover, there is disclosed a method to increase the octane blending value of reformate produced from a catalytic reformer in a petroleum refinery having a reformer feed stream, said method comprising: adding a manganese-containing oxidation catalyst to the reformer feed stream, whereby octane blending value of reformate produced is increased relative to the octane blending value of reformate produced in the petroleum refinery without the addition of the manganese-containing oxidation catalyst.

Further, there is disclosed a catalytic reformer system wherein the improvement comprises adding a manganese-containing compound to a naphtha feed stream.

### DESCRIPTION OF THE EMBODIMENTS

The present disclosure relates in one embodiment to a catalytic reformer system comprising a feed stream to a catalytic reformer and a reforming catalyst. The feed stream to the catalytic reformer can comprise naphtha and at least one manganese-containing compound. The reforming catalyst can comprise a support, at least one noble metal on the support, and optionally at least one free manganese species deposited on the support and on the noble metal.

The naphtha feed stream can supply a manganese-containing compound to the reforming catalyst that can inhibit coking and/or can yield a catalyzed coke that oxidizes more readily at milder conditions than those typically associated with conventional oxidative regeneration. Moreover, the manganese-containing compound present in the feed stream described herein can improve the octane blending quality of the reformate product; and scavenge catalyst poisons, such as sulfur from the naphtha feed stream into the catalytic reformer.

Naphtha is a mixture of many different hydrocarbon compounds. It has an initial boiling point of about 35° C. and a final boiling point of about 200° C., and can comprise paraffinic, naphthenic (cyclic paraffins) and aromatic hydrocarbons ranging from those containing 4 carbon atoms to those containing up to about 10 or 11 carbon atoms.

The naphtha stream produced by crude oil distillation is often further distilled to produce a “light” naphtha comprising most (but not all) of the hydrocarbons with 6 or less carbon atoms and a “heavy” naphtha comprising most (but not all) of the hydrocarbons with 6 or more carbon atoms. The heavy naphtha has an initial boiling point of about 80 to 100° C. and a final boiling point of about 180 to 205° C. The naphthas derived strictly from the distillation of crude oils are referred to as “straight-run” naphthas.

It is the straight-run and other heavy naphthas that are usually processed in a catalytic reformer because the light naphtha comprises molecules with less than 6 carbon atoms which, tend to crack into butane and lower molecular weight hydrocarbons in a reforming unit and are more effectively processed into desirable gasoline blending components in an isomerization reactor.

The naphtha feed stream into the reformer can by the present disclosure be additized with from about 0.05 to about 1000 mg/L of a manganese-containing compound.

In a further aspect, the manganese-containing compound is or comprises methylcyclopentadienyl manganese tricarbonyl (MMT®). MMT can decompose in the catalytic reformer system at about 420° C. thereby resulting in free manganese species. As used herein, “free manganese species” means it is selected from the group consisting of free manganese atoms, to clusters, to nanoparticles, to macro particles that are visible to the eye. Because the manganese-containing compound is decomposing in a fuel rich environment, there should not be significant manganese oxides; however, some may be present. If the feed stream contains sulfur, as discussed in further detail below, then the range of free manganese species will be diminished equal to the amount of manganese that react with sulfur. The resultant sulfates will also range from individual free molecules of manganese-, sulfur-containing compounds to respective clusters, nanoparticles, macroparticles, etc.

In the event, that the manganese-containing compound does not decompose in the catalytic reformer system, the manganese-containing compound can pass unconverted into the reformate thereby increasing its octane blend value.

In the case of a manganese-containing compound, there are numerous compounds that include methylcyclopentadienyl manganese tricarbonyl, manganocene, and many other monomanganese organometallics that exist in the literature. There are also binuclear metallics such as manganese heptoxide (Mn₂O₇), manganese decacarbonyl (Mn₂(CO)₁₀), etc. An example of a trinuclear manganese cluster is manganese II citrate, (Mn₃(C₆H₅O₇)₂).

Manganese-containing compounds can include, for example, manganese tricarbonyl compounds Such compounds are taught, for example, in U.S. Pat. Nos. 4,568,357; 4,674,447; 5,113,803; 5,599,357; 5,944,858 and European Patent No. 466 512 B1, the disclosures of which are hereby incorporated by reference in their entirety.

Suitable manganese tricarbonyl compounds which can be used include, but are not limited to, cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tert-butylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, indenyl manganese tricarbonyl, and the like, including mixtures of two or more such compounds. One example is the cyclopentadienyl manganese tricarbonyls which are liquid at room temperature such as methylcyclopentadienyl manganese tricarbonyl, ethylcyclopentadienyl manganese tricarbonyl, liquid mixtures of cyclopentadienyl manganese tricarbonyl and methylcyclopentadienyl manganese tricarbonyl, mixtures of methylcyclopentadienyl manganese tricarbonyl, and ethylcyclopentadienyl manganese tricarbonyl, etc.

Preparation of such compounds is described in the literature, for example, U.S. Pat. No. 2,818,417, the disclosure of which is incorporated herein in its entirety.

Additional non-limiting examples of manganese-containing compounds include non-volatile, manganese-containing compounds such as bis-cyclopentadienyl manganese, bis-methyl cyclopentadienyl manganese, manganese naphthenate, manganese II citrate, etc, that are either water or organic soluble. Further examples include non-volatile, manganese-containing compounds embedded in polymeric and/or oligomeric organic matrices, such as those found in the heavy residue from the column distillation of crude MMT®.

As discussed above, the free manganese species generated in situ can deposit on the reforming catalyst. Commonly used catalytic reforming catalysts comprise at least one noble metal, which includes previous metals, chosen from ruthenium, rhodium, palladium, silver, osmium, iridium, platinum, and gold. The noble metal is present on a catalytic support. In an aspect, the catalyst can be multimetallic, such as bimetallic.

In particular, the free manganese species can deposit on the catalyst surface as islands of manganese agglomerates (i.e., clusters, nanoparticles, macroparticles). The free manganese species can then 1) scavenge sulfur from the feed stream and/or 2) catalytically reform the feed stream to reformate, hence contributing to yield of reformate.

Also, when the reformer efficiency falls below a specified set point necessitating regeneration, the free manganese species deposited on the catalyst would facilitate coke oxidation at a lower temperature than if the free manganese species were absent.

It is anticipated that this thin reactive layer of free manganese species on the surface of the catalyst can act as a secondary reforming catalyst.

Moreover, one could optimize the octane blend of the reformate by monitoring the catalyst so that at optimal performance there is an increase in a research octane number and at its lowest performance there is a decrease in the research octane number.

The catalyst can be maintained at an optimal performance, e.g., by increasing its durability/longevity, by, for example, inhibiting coking and/or poisoning of the catalyst.

Regeneration of a deactivated catalyst involves burning off the accumulated coke under carefully controlled conditions, such as at about 425° C. or less. The system is purged with nitrogen and cooling and then burning off the carbon with a gas stream containing about 0.5% to 1.0% oxygen. This procedure is performed over a period of several days so that the bed temperature never exceeds 425° C. The temperature control is designed to prevent sintering of the noble metal.

It is possible by the process described herein to increase the durability of the catalyst by using milder oxidation conditions, such as by lowering the temperature of the regeneration reaction without affecting the BTU yield from the coke oxidation or by reducing the amount of oxygen present in the regenerative gas stream. Addition of the manganese-containing compound should achieve this.

The concentrations of impurities in the feed that can act as poisons must also be controlled. Sulfur poisons the metal function of the catalyst and can be maintained at concentrations less than about 1 ppm in the feed contacting the catalyst. Moreover, organic nitrogen compounds can be converted into ammonia and poison the acid function of the reforming catalyst so their concentration should be kept below about 2 ppm. Further arsenic, lead, and copper need to be kept at extremely low concentrations because they can alloy with the noble metal component of the catalyst or otherwise deactivate it. As an example, severe poisoning by arsenic has been reported with 30 ppb of arsenic in the feed. Generally molecules containing elements of Group VB (N, P, As, Sb) and Group VIB (O, S, Se, Te) can be strong catalyst poisons, depending on the electronic structures of the compounds containing them.

The addition of at least one manganese-containing compound to the naphtha stream would supply the free manganese species to scavenge poisons from the reformer feed. The naphtha feed stream to the reformer should be zero sulfur. However, if residual sulfur, even as low as 5 ppm, is present, reforming catalyst durability would be significantly enhanced if that sulfur is scavenged away and not allowed to poison the noble metals of the reforming catalyst.

Alternatively, one could use a higher level of sulfur in the reformer feed, such as about 5 ppm and thereby reduce the cost of removing the sulfur in the naphtha hydrotreater. The free manganese species in the reformer, which has been generated in situ, can scavenge the sulfur to a reduced amount as before prior to contacting and poisoning the noble metals of the reforming catalyst.

By “scavenging” herein is meant the contacting, combining with, reacting, incorporating, chemically bonding with or to, physically bonding with or to, adhering to, agglomerating with, affixing, inactivating, rendering inert, consuming, alloying, gathering, cleansing, consuming, or any other way or means whereby a first material makes a second material unavailable or less available.

Chlorine is continually stripped from the surface of the catalyst as HCl by reaction with small amounts of water in the feed (or water produced from oxygen in the feed). The chlorine content of the catalyst therefore must be maintained by adding chlorinated organic compounds to the feed in order to keep catalyst acidity within a suitable range. The appropriate level of catalyst acidity is dictated by the need to balance the rates of desirable reactions like isomerization and dehydrocyclization against the potentially negative impacts of hydrocracking. If the chlorine content of the catalyst becomes too low, the acidity drops and the desirable reactions that occur on the acid centers, e.g., isomerization and dehydrocyclization, slow to an unacceptable rate. This reduces the octane number of the resulting reformate. If excessive chlorine (or too little water) is present and catalyst acidity is too high, then hydrocracking increases to an unacceptable level, and the reformate octane value and product yield also drop.

Reforming unit performance and durability could be further enhanced through the addition of a co-additive comprising an alkyl chloride, sufficient to provide at least one chlorine to every manganese from the manganese-containing compound to the feed stream. The chlorine provides active sites on the catalyst.

Typical reformer operating conditions include temperatures from about 460° C. to about 525° C. and can be usually from about 482° C. to about 500° C. High pressure processes are run at about 34 to about 50 atm. Low-pressure processes, such as 8.5 to 10.5 atm, can be operated at slightly higher temperatures than the others to optimize conversion to high-octane-number products. The space velocity ranges from 0.9 to 5 vol of liquid feed per volume of catalyst per hour, with 1 to 2 most common. Moreover, the hydrogen-to-hydrocarbon-feed mole ratios vary from 3 to 10, and ratios of 5 to 8 can be used. As catalysts lose activity in operation, the reactor temperature can be gradually increased to maintain a constant octane number in the product reformate.

The use of milder oxidation conditions during regeneration can result in better retention of catalyst activity by minimizing noble metal sintering and loss of active catalyst surface area.

The following examples further illustrate aspects of the present disclosure but do not limit the present disclosure.

At numerous places throughout this specification, reference has been made to a number of U.S. patents, published foreign patent applications and published technical papers. All such cited documents are expressly incorporated in full into this disclosure as if fully set forth herein.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

Applicant does not intend to dedicate any disclosed embodiments to the public, and to the extent any disclosed modifications or alterations may not literally fall within the scope of the claims, they are considered to be part of the invention under the doctrine of equivalents.

What is claimed is:

1. A feed stream to a catalytic reformer comprising naphtha and at least one manganese-containing compound.

2. The feed stream of claim 1, wherein the at least one manganese-containing compound is selected from the group consisting of cyclopentadienyl manganese tricarbonyl, methylcyclopentadienyl manganese tricarbonyl, dimethylcyclopentadienyl manganese tricarbonyl, trimethylcyclopentadienyl manganese tricarbonyl, tetramethylcyclopentadienyl manganese tricarbonyl, pentamethylcyclopentadienyl manganese tricarbonyl, ethylcyclopentadienyl manganese tricarbonyl, diethylcyclopentadienyl manganese tricarbonyl, propylcyclopentadienyl manganese tricarbonyl, isopropylcyclopentadienyl manganese tricarbonyl, tert-butylcyclopentadienyl manganese tricarbonyl, octylcyclopentadienyl manganese tricarbonyl, dodecylcyclopentadienyl manganese tricarbonyl, ethylmethylcyclopentadienyl manganese tricarbonyl, and indenyl manganese tricarbonyl.

3. The feed stream of claim 1, wherein the at least one manganese-containing compound is selected from the group consisting of methyl cyclopentadienyl manganese tricarbonyl, cyclopentadienyl manganese tricarbonyl, and mixtures thereof.

4. The feed stream of claim 1, wherein the at least one manganese-containing compound is present in an amount ranging from about 0.05 to about 1000 mg/L.

5. The feed stream of claim 1, wherein the naphtha is a full-range naphtha.

6. The feed stream of claim 1, wherein the naphtha is a heavy naphtha.

7. The feed stream of claim 1, further comprising alkyl chloride.

8. A catalytic reformer system comprising:
a feed stream comprising naphtha and at least one manganese-containing compound; and
a catalyst.

9. The system of claim 8, wherein free manganese species has been deposited on the catalyst.

10. The system of claim 9, wherein the free manganese species is selected from the group consisting of free manganese atoms, clusters of manganese, manganese nanoparticles, and manganese macroparticles that are visible to the eye.

11. The system of claim 8, further comprising at least one manganese-, sulfur-containing compound.

12. A reformer catalyst comprising:
a support;
a noble metal on the support; and
a deposit of free manganese species on the catalyst.

13. A method to improve the durability of a reformer catalyst comprising: adding to a naphtha feed stream at least one manganese-containing compound, wherein the at least one manganese-containing compound decomposes and deposits free manganese species on the reforming catalyst.

14. The method of claim 13, wherein the free manganese inhibits coking of, on, or in the reforming catalyst.

15. The method of claim 13, wherein the free manganese is present at a level sufficient to scavenge sulfur from the reformer feed.

16. The method of claim 13, wherein milder oxidation conditions results in better retention of catalyst activity by minimizing noble metal sintering and/or loss of active catalyst surface area during catalyst regeneration

17. The method of claim 13, further comprising adding to the naphtha feed stream a co-additive comprising an alkyl chloride, in an amount sufficient to provide at least one chlorine atom for each manganese atom from the manganese-containing compound.

18. A method to increase the octane blending value of reformate produced from a catalytic reformer in a petroleum refinery having a reformer feed stream, said method comprising: adding a manganese-containing oxidation catalyst to the reformer feed stream, whereby octane blending value of reformate produced is increased relative to the octane blending value of reformate produced in the petroleum refinery without the addition of the manganese-containing oxidation catalyst.

19. A catalytic reformer system wherein the improvement comprises adding a manganese-containing compound to a naphtha feed stream.

20. A reformate product produced by the process of claim 18.
